(19) United States
(12) Patent Application Publication
(10) Pub. No.: US 2007/0082110 A1
(43) Pub. Date: Apr. 12, 2007

(54) Food product kit

(76) Inventors: Wayne Gerald Morley, Ipswich (GB); Lucy Thomas, London (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/573,563

(22) PCT Filed: Sep. 10, 2004
(86) PCT No.: PCT/EP04/10130

§ 371 Date: Mar. 27, 2006

(30) Foreign Application Priority Data
Oct. 1, 2003 (EP) 03256212.6

(51) Int. Cl. A23D 9/00

(52) U.S. Cl. 426/601

(57) ABSTRACT

The invention provides a kit for preparing salads comprising at least one cooked ingredient and at least one fruit, vegetable or cereal product, wherein the kit comprises a cooking composition comprising less than 40% wt of fat and flavouring agents in an amount of from 5 to 100% by weight, based on the weight of the cooking composition, for cooking ingredient (I) and, a dressing comprising 60% wt or less fat for contacting with the at least one fruit, vegetable or cereal product. The kit provides an easy and convenient of preparing tasty, healthy salads comprising a cooked food ingredient. A method of making a salad using the kit and also the salad prepared from the kit is also provided.

### FIELD OF THE INVENTION

The present invention relates to a kit for preparing salads comprising a cooked food ingredient and at least one fruit, vegetable or cereal product. The invention also relates to a process for preparing salads and to the salads prepared by the process and/or by the use of the kit.

### BACKGROUND ART

Consumers are becoming increasingly interested in healthy eating and in particular in meals which are considered healthy (especially in terms of fat content) but which still taste good. There is also a consumer desire for healthy meals that are nutritious and tasty, yet, quick and convenient to prepare.

Salad meals are becoming increasingly popular and are no longer consumed simply as an accompaniment to a main meal. However, when salads are eaten as a main meal they still need to be nutritionally balanced and therefore the fruit, vegetables or cereal products used in the salads are generally eaten with a protein-rich source such as chicken, eggs, meat, fish or vegetable-derived protein source e.g. tofu or beans or with cooked vegetables, such as roasted vegetables, or even with bread which is cooked.

These protein-rich sources or vegetables need to, or are desired to, be cooked before being used in the salad and it is important that they are cooked in a way that provides for a well cooked, tasty, product. It is also important that the cooking method is convenient for the consumer.

The other component of the salad, the fruit, vegetables or cereal products, also need to have a good taste and texture and so are generally used in combination with a dressing. The consumer can then choose different flavours to make salads varied and more interesting.

The requirements of an easy-to-prepare, nutritious, tasty and yet healthy salad meal have been found in practice to not be so simple to provide because to achieve the aforementioned requirements the consumer will typically add a significant amount of oil. Furthermore, flavourings are often added in addition to the cooking oil and to the salad dressing and these flavourings may themselves contain oil.

Accordingly, there is a need in the art to provide healthy, nutritious meals which are convenient to prepare but which have a good taste and texture.

In particular, there is a need to provide such salad meals which have a controlled fat content.

The present invention seeks to address one or more of the above-mentioned problems.

In particular, it seeks to provide salad meals which are healthy and nutritious but which are convenient to prepare and have a good taste and texture.

It also seeks to provide such salad meals which have a controlled fat content.

### SUMMARY OF THE INVENTION

Surprisingly, we have now found that at least one of the above-mentioned problems is addressed by a kit for making salads, which kit comprises a cooking composition for cooking an ingredient of the salad and also a dressing which has a controlled level of fat for contacting with the other ingredients in the salad.

Thus according to a first aspect of the present invention there is provided a kit for preparing salads comprising at least one ingredient (I) which is cooked and at least one fruit, vegetable or cereal product, wherein the kit comprises;
a) a cooking composition comprising less than 40% wt of fat and flavouring agents in an amount of from 5 to 100% wt, based on the weight of the cooking composition, for cooking ingredient (I) and
b) a dressing for contacting with the at least one fruit, vegetable or cereal product, which dressing comprises from 60% wt or less fat based on the weight of the dressing.

It is especially preferred that the cooking composition comprises less than 5% wt of hardened fats, based on the weight of the fat in the composition. This is desirable from a nutritional standpoint.

It is preferred that the cooking composition comprises up to 30% wt fat.

It is preferred that the dressing is an emulsion, especially, an oil-in-water emulsion. It is also preferred that the dressing comprises 10-40% wt fat.

The kit allows for the convenient and easy preparation of nutritious salads, especially salads that are intended to be eaten as a main course or a nutritionally balanced side dish. The kits of the invention are suitable for consumers seeking healthy, yet tasty, meals as a controlled amount of fat is present in the kit. Also the salads have good taste and texture and are easy to prepare and large amounts of oil are not required during the cooking process for the cooked ingredient.

Furthermore, because the cooking composition and the dressing form a kit for preparing salads, this allows the flavours of each product to be matched so that they complement or contrast with each other as desired, thus providing convenient and tasty salad options for the consumer.

According to a second aspect of the invention, there is provided a process for preparing a salad comprising at least one ingredient which is cooked and at least one fruit, vegetable or cereal product, the process comprising the steps of 1) cooking the at least one ingredient, in a cooking composition comprising less than 40% wt of fat and flavouring agents in an amount of from 5 to 100% by weight, based on the weight of the cooking composition, to produce at least one cooked ingredient (I), and 2) contacting the at least one fruit, vegetable or cereal product with a dressing comprising from 60% wt or less fat and 3) mixing the at least one cooked ingredient (I) with the at least one fruit, vegetable or cereal product before, during or after the fruit, vegetable or cereal product is mixed with the dressing and wherein the cooking composition and the dressing are provided as a kit for preparing a salad.

In addition to the presence of the cooking composition during the cooking of the at least one cooked ingredient (I), additional fat may be added during the cooking process to aid the same. However, it has been found that if additional fat is added during the cooking process, only minimal levels are required as detailed hereinbelow.

The method allows for the quick and convenient preparation of salads which are nutritious and which have a controlled content of fat.

According to a third aspect of the invention, there is provided a salad comprising at least one ingredient (I) which is cooked and at least one fruit, vegetable or cereal product and which is prepared using the kit of the first aspect of the invention and/or by the process of the second aspect of the invention.

The term ‘fat and oils’ as used herein are interchangable.

The term ‘fish’ as used herein includes shellfish.

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

Except in the operating and comparative examples, or where otherwise explicitly indicated, all numbers in this description indicating amounts of material or conditions of reaction, physical properties of materials and/or use are to be understood as modified by the word “about.” All amounts are by weight, based on the total weight of the relevant product, unless otherwise specified.

### DETAILED DESCRIPTION OF THE INVENTION

a) Cooking Composition

The cooking composition is used to flavour ingredient (I) by at least partially cooking that ingredient in the composition. Any suitable cooking method may be employed including frying, baking, grilling, steaming and micro-waving. Boiling is not preferred because the product tends to become removed from ingredient (I) and does not then flavour it as well as in the other methods. The cooking composition can also be used to marinade the ingredient (I) which is later cooked with the product still in contact with it.

The cooking composition may be of any suitable physical type, such as a liquid, a paste, a powder or granular product. The physical type of the cooking composition may be chosen according to the flavouring requirements of the cooking composition. For example, if a composition comprising a very intense flavour is required then a powder product comprising high levels of flavouring agents may be used rather than a liquid product using lower levels of flavouring agents. The physical format of the cooking composition may require that oil is added during the cooking process, or, it may influence the amount of oil that is added. For example, more oil may typically be added during the cooking process if the cooking composition is a powder than if it is a paste to avoid the cooking composition burning.

The cooking composition comprises less than 40% wt fat, preferably less than 30% wt fat, most preferably 1 to 20% wt fat based on the weight of the cooking composition. According to one embodiment of the present invention, the cooking composition comprises 0 to 10% wt fat, based on the weight of the composition, preferably 0.5 to 5% wt fat.

The fat in the cooking composition may be any edible fat such as animal derived fats, dairy derived fats (such as butter) or those of vegetable origin, especially triglyceride oils of vegetable origin. Vegetable oils are especially preferred.

The following vegetable derived liquid fats (oils) have been found to be especially suitable for use in the cooking composition; olive, rapeseed, sunflower including high oleic sunflower oil, corn, maize, soy bean, palm, sesame, coconut, linola, canola, cottonseed, safflower including high oleic safflower oil, linseed oil, coconut oil, arachidic oil, olein-fractions of natural oils, such as palm oil olein and mixtures thereof. Medium chain triglyceride oils may be used. Mixed vegetable oil is also suitable.

It is preferred that the cooking composition comprises less than 10% wt, based on the weight of the fat in the composition, of hardened fats, more preferably less than 5% wt, most preferably less than 2% wt, such as less than 1% wt. According to one embodiment of the invention, the fat in the cooking composition is substantially free of hardened fat. Examples of hardened fats are hardened rapeseed oil, hardened sunflower seed oil, hardened soybean oil, hardened palm oil, hardened cottonseed oil and hardened high erucic rapeseed oil.

The cooking composition comprises flavouring agents in amounts of from 5 to 100% wt, preferably 10 to 90% wt, most preferably 20 to 80% wt, such as 30 to 70% wt. The types and amounts of flavourings will depend upon the final flavour and flavour intensity required. The flavours may be natural or artificial and may be added as compositions, powders, liquids or solids etc.

Typical flavourings include honey, herbs, nuts, seeds, vegetables, spices including mustard, fruit, sugar, salt, pepper, animal flavourings such as meat, poultry or fish flavourings, alcoholic flavours such as wine or brandy etc, dairy products such as cheese or yoghurt. Herbs are defined in The Illustrated Herbal Handbook by J. de Baïracli Levy, Faber and Faber Ltd., Londen, chapter 3. Spices are defined in “The Book of Spices”, Livingstone Publ. Comp. 1969, p. 3.

Flavour enhancers, such as monosodium glutamate, may be used in the cooking composition, typically in amounts of up to 1 % wt.

Depending upon the physical format of the cooking composition it may comprise water in amounts of up to 10% wt, preferably 0 to 5% wt water, most preferably 0 to 2% wt. The lower amounts of water are preferred as they give better microbiological stability to the product. It is especially preferred that the cooking composition is prepared without added water, so that any water content is present from the ingredients themselves. It is also preferred that at least one of the cooking composition ingredients is dried before being used to produce the cooking composition.

The cooking composition may comprise one or more thickeners. Any conventional thickener such as natural or modified starches including hydrolysed starches, celluloses, alginates and natural or modified gums including (iota) carrageenan, guar gum, locust bean, xanthan gum or gelatin may be used. Typical amounts for the thickener are in the range of from 0.05 to 2 or 5% wt, more preferably 0.1 to l.5% wt, most preferably 0.1 to 1% wt thereof.

An emulsifier may be included in the cooking composition and any suitable edible emulsifier may be included. It is preferred that the emulsifier comprises an egg yolk derived emulsifier, most especially one selected from egg yolk, stabilized egg yolk, fortified stabilized egg mix, dried egg yolk, salted egg yolk, enzymatically treated egg yolk such as (spray) dried egg-yolk powder stabilised using an enzyme having phospholipase A2 activity and whole eggs. Blends of any of the preceding types with egg white may also be used. The cooking composition may comprise an amount of from about 0.5 or 1 to 8% wt of emulsifier, more preferably from 2 to 7% wt, most preferably 3 to 6% wt for egg derived emulsifiers. For non-egg derived emulsifiers such as lecithin and monoglycerides, the products preferably comprise an amount of from about 0.05 or 2% wt non-egg derived, more preferably from 0.1 to l% wt, most preferably 0.2 to 0.8% w.

The cooking composition may comprise milk-proteins, which can be added as milk, skimmed milk powder or as full milk powder. The amount used is preferably in the range from 1-8 wt %, in particular from 2-6 wt %.

In addition to the presence of the cooking composition during the cooking of the at least one cooked ingredient (I), additional fat may be added during the cooking process to aid the same. However, it has been found that if additional fat is added during the cooking process, only minimal levels are required. It is preferred that if oil is added during the cooking process, the amount of oil added is in the range of from 5-60% wt, more preferably 10-50% wt , most preferably 20-50% wt based on the total of the weight of added oil plus the weight of the cooking composition.

The cooking composition may be mixed with hot water, hot milk, stock, or other hot aqueous liquid, e.g. having a temperature of >80° C., preferably 85-99° C., in particular 90-95° C., prior to cooking ingredient (I) without having lumping or caking problems. The amount of water, milk, or aqueous liquid used depends on the thickness and taste requirements of the user. Typical dilution rates are 1 part of the cooking composition to between 3 to 8 parts, preferably 4-6 parts, of aqueous liquid. After the mixing of the ingredients the composition should ideally be kept at the high temperature for some minutes for cooking purposes and to ensure thickness.

Alternatively, the cooking composition may be added to a cold aqueous liquid. (e.g. water, wine, milk, stock, etc.), whereafter heat may be suitably applied to achieve a thickening effect.

The Dressing

The dressing is used for contacting with the at least one fruit, vegetable or cereal product, and comprises from 0 to 60% wt fat based on the weight of the dressing. It is also preferred that the dressing comprises 10-40% wt fat, more preferably 15 to 35% wt fat. The fats disclosed hereinabove for the cooking composition may also be used for the dressing.

Typically the dressing is contacted with the at least one fruit, vegetable or cereal product by mixing with, or being poured over the latter. This may happen either before, after or during when the ingredient which is cooked in the cooking composition is added.

It is preferred that the dressing is an emulsion, especially, an oil-in-water emulsion. Salad dressings are especially preferred according to the invention.

The dressing preferably comprises flavouring agents, typically in amounts of from 0.1 to 20% wt, preferably 0.5 to 15% wt, most preferably 1 to 10% wt. The types and amounts of flavourings will depend upon the final flavour and flavour intensity required and the same types as disclosed above for the cooking composition may be used.

Flavour enhancers, such as monosodium glutamate, may be used in the dressing, typically in amounts of up to 1% wt.

The dressing preferably comprises water, especially in an amount of from 5 or 10 to 65% wt water based on the weight thereof, preferably 15 to 50% wt, most preferably 20 to 45% wt.

The dressing may be, for example, a liquid, a gel or as a spoonable product (such as a low fat mayonnaise) as desired.

The dressing may comprise one or more thickeners and the same types may be used as disclosed for the cooking composition. Typical amounts for the thickener are in the range of from 0.05 to 3 % wt, more preferably 0.1 to 2 % wt, most preferably 0.1 to 1.5 % wt thereof.

An emulsifier is typically included in the dressing to aid the formation and/or aid the stability thereof. Any suitable edible emulsifier may be included and those disclosed above for the cooking composition are suitable in the same amounts.

The dressing may comprise the same types and amounts of milk-proteins as described hereinabove for the cooking composition.

The dressings preferably have a pH at 20° C. in the range of from 3.0 to 5.0. The exact pH will depend upon the flavour desired and whether preservatives are also present therein. At the more acidic pHs, added preservatives are often not necessary as the low pH inhibits the growth of pathogens and/or spoilage yeasts or moulds.

In an especially preferred embodiment, the dressing has a pH at 20° C. in the range of from 3.2 to 4.5, more preferably of from 3.4 to 4.0.

The dressing preferably has an undissociated (acetic) acid content in the aqueous phase of the emulsion of up to 3% wt based on the weight of the aqueous phase, preferably of from 0.1 to 2% wt, more preferably of from 0.1 to l.5% wt, most preferably of from 0.5 to 1.5 % wt.

The acid content may be provided by the inclusion of any edible acid in a suitable amount to achieve the desired pH range. These acids are present in the aqueous phase of the emulsion and suitable edible acids include acetic acid, citric acid, edible hydrochloric acid, edible phosphoric acid, malic acid, tartaric acid, gluconic acid and lactic acid amongst others.

The dressing may contain sweetening agents such as sugar, sugar solutions or artificial sweeteners in any suitable amounts.

Other Optional Ingredients

The cooking composition and the dressing may individually comprise one or more additional optional ingredients selected from preservatives such as ascorbic acid or salts thereof, sugar, stabilisers, colourings etc. The amount of these optional ingredients will depend upon the type of ingredient included and the desired taste but will typically be in the range of from 0.05 to 5% by weight per type of ingredient. The cooking composition may also optionally comprise edible acids in amounts of up to 5% wt.

An edible salt is preferably included in either the cooking composition or the dressing, preferably both, and can be derived from inorganic or organic acids or bases. The most preferred edible salt is NaCl. The preferred amount of the edible salt is in the range of from 2-7 wt % based on the weight of the composition.

Extracts from meat, fish, fruit or vegetables may also be used in either the cooking composition or the dressing. Typically amounts will be in the range of from 1 to 30% wt based on the total weight of the product, preferably 2 to 28% wt.

When the cooking composition comprises fat, the weight ratio of the fat in the cooking composition to the fat in the dressing, based on the total weight of the cooking composition plus dressing, is preferably in the range of from 2:1 to 1:300, more preferably 2:1 to 1:100, more preferably 2:1 to 1:50, more preferably 1:1 to 1:20, such as 1:5 to 1:15 and all ranges subsumed therein.

Process to Prepare the Cooking Composition/the Dressing

The cooking composition and the dressing may be prepared by any suitable process, using any suitable apparatus, for producing such products. Suitable methods are well know in the art and do not need to be described in detail here. The exact process chosen for the cooking composition may depend upon the level of oil in the composition. For example, if no oil is present then dry ingredients may simply be blended together. If oil is present, the ingredients may, for example, be combined and mixed until the required product viscosity/homogeneity is formed. Alternatively, the ingredients may be heated and homogenised followed by cooling e.g. under shear.

A pasteurisation or sterilisation step (including a U.H.T. step) may be carried out at any time during the process; either on the final product or at any time during the process. Normal conditions for pasteurisation treatments may be used e.g. treatment at 80-90° C. for a period of from 1 to 10 minutes.

A suitable method to prepare the cooking composition, including when it comprises a thickener and a liquid oil is disclosed in EP-A-977 490.

Kit

The kit may be prepared according to any suitable method. For example the kit may be sold as comprising a container of the cooking composition and a container of the dressing packaged together, for example by shrink wrapping or by otherwise being provided together in a package. The cooking composition and the dressing may also form part of the same container which has been separated into sections.

The amounts of the cooking composition and the dressing included in the kit will vary upon the number of portions of salad for which the kit is intended and also upon the flavours of the cooking sauce and dressing. For example a very strongly flavoured cooking composition or dressing may be provided in smaller quantities in the kit than a very mildly flavoured one. Typically, for a salad for two people, 10-100 g, preferably 15-70 g, most preferably 20-40 g, such as 25 g, of the cooking composition and 50-500 g, preferably 80-250 g, most preferably 100-200 g, such as 150 g, of the dressing will be included in the kit. This kit would typically be used with 100 to 400 g, preferably 150 - 300 g, such as 200g in total of fruit, vegetable or cereal product and 100 to 400 g, preferably 200-350 g, such as 300 g in total of the ingredient (I) which is cooked in the cooking composition.

The tastes of the cooking composition and the dressing present together in the kit can be chosen to be contrasting or complementary, for example tomatoes and herbs, salsa and lime etc.

It is preferred that the total fat content of the cooking composition and the dressing combined in the kit is in the range of from 5 to 50% wt, more preferably 10 to 45% wt, most preferably 15 to 40% wt.

The weight ratio of the amount of cooking composition in the kit to the amount of dressing in the kit is preferably in the range of from 1:20 to 2:1, more preferably 1:10 to 1:1, based on the total weight of the dressing and cooking composition.

Salad Ingredients

The ingredient (I) which is cooked in the cooking composition may be any food ingredient which it is desired to cook and add to a salad. It is especially preferred that the ingredient is a protein-rich source such as chicken, egg, meat, fish, a vegetable-derived protein source e.g. tofu or beans, or, other foods which are cooked such as cooked fruit or vegetables. Bread may also be cooked in the cooking composition to provide a flavoured bread cooked ingredient.

The salad also comprises at least one fruit, vegetable or cereal product which may be cooked or uncooked. However, if it is cooked (such as rice or pasta) then there must be at least one other ingredient, or portion of the same ingredient, which is cooked in the cooking composition. The fruit can be any fruit and the vegetable can be any vegetable including salad leaves and salad vegetables. The cereal may be any cereal such as couscous, rice, pasta, croutons etc.

The salad can also include other additional ingredients such as cheese, raw meat, fish and poultry and also cooked meat, fish and poultry which have not been cooked in the cooking composition.

Making the Salad

Methods of making the salad are given hereinabove according to the second aspect of the invention. Any suitable method can be used to produce the salad as long as ingredient (I) is cooked in the cooking composition and the at least one fruit, vegetable or cereal product is contacted with the dressing.

The invention is further exemplified by the following examples, which are to be understood as to be non-limiting. Further examples within the scope of the invention will be apparent to the person skilled in the art.

### EXAMPLES

### Example 1

A cooking composition and a pourable oil-in-water emulsion salad dressing were prepared according to the following formulations using the methods given below:

TABLE 1
The cooking composition

| Ingredient | Level (% w/w) |
|---|---|
| Sugar | 19.81 |
| Tomato powder | 16.46 |
| Coriander | 16.02 |
| Cumin | 16.02 |
| Garlic powder | 6.97 |
| Tomato flavour | 6.22 |
| Wine extract white | 6.22 |
| Salt | 2.62 |
| White mustard flour | 5.60 |
| Black pepper | 2.49 |
| Chilli extract | 1.15 |
| Colour | 0.40 |

The cooking composition was prepared by mixing together the ingredients at room temperature using a conventional food mixer and then putting into jars in 25 g portions.

TABLE 2
Cheese and herb salad dressing

| Ingredient | % wt |
|---|---|
| Water | 42.32 |
| Sucrose/glucose syrup | 11.98 |
| Vinegar 12% | 6.23 |
| Xanthan gum | 0.26 |
| Egg yolk powder | 1.56 |
| Starch | 1.04 |
| Salt | 2.59 |
| Potassium sorbate | 0.16 |
| Vegetable oil | 28.22 |
| Flavouring mix: including Parmesan cheese and basil | 5.64 |

The oil-in-water salad dressing was prepared by combining all of the ingredients together at room temperature, emulsifying in a high speed mixer, and then putting the salad dressing in 150 gram portions into suitable jars.

The cooking composition and the salad dressing jars were secured together using a full-body sleeve to produce a kit for preparing salads, the kit comprising a container comprising 25 grams of the cooking composition and a container 150 grams of the pourable salad dressing.

25 grams of the cooking composition was used to stir-fry 300 grams of chicken strips as detailed below in a non-stick frying pan. Where indicated, sunflower oil was added to the cooking composition to aid the final taste and cooking of the chicken.

TABLE 3
Cooking results

| | Oil | | |
|---|---|---|---|
| | added | Method | Result |
| 1 | None | Chicken cooked with | Looked good, did not burn. |
| | | cooking composition | Tasted a bit powdery. |
| 2 | 10 g | Oil and cooking | Looked good, slightly |
| | | composition placed in | burnt. Tasted good, not |
| | | pan. Chicken added | powdery. |
| | | and then cooked | |
| 3 | 20 g | Oil and cooking | Looked good, slightly |
| | | composition placed in | burnt. Tasted good, not |
| | | pan. Chicken added | powdery. |
| | | and then cooked | |
| 4 | 30 g | Oil and cooking | Acceptable although very |
| | | composition placed in | burnt. Taste a little |
| | | pan. Chicken added | bland. |
| | | and then cooked | |
| 5 | 30 g | Chicken cooked in | Poor result. Meat not |
| | | oil. cooking | infused. Slimy texture on |
| | | composition added 2 | surface. |
| | | mins before end | |
| 6 | 30 g | Oil and cooking | Acceptable, similar to |
| | | composition | previous method with |
| | | thoroughly mixed. | composition (number 4). |
| | | Chicken added and | |
| | | cooked. | |
| 7 | None | A few grams of | Good result, not as much |
| | | cooking composition | flavour as previous tests. |
| | | sprinkled on chicken | |
| | | and then grilled. | |
| 8 | Brushed | Chicken brushed with | Good result, not as much |
| | | oil. A few grams of | flavour as previous tests. |
| | | cooking composition | |
| | | sprinkled on and then | |
| | | grilled. | |

To make a warm salad 300 g of chicken strips is cooked (stir-fried) in 25 g of the cooking composition, with a minimum amount of oil added thereto to aid the cooking of the chicken. To this is added 200 g of salad leaves and 150 grams of the salad dressing and the mixture is stirred to produce the salad meal. The salad has a good taste, is quick and convenient to prepare and does not contain high levels of oil. With the compositions in Table 3 the preferred amount of added oil is 0-30 g and preferably 10-120 g.

1. A kit for preparing salads comprising at least one ingredient (I) which is cooked and at least one fruit, vegetable or cereal product, wherein the kit comprises;
a) a cooking composition comprising less than 40% wt of fat and flavouring agents in an amount of from 5 to 100% by weight, based on the weight of the cooking composition, for cooking ingredient (I), and
b) a dressing for contacting with the at least one fruit, vegetable or cereal product, which dressing comprises 60% wt or less fat based on the weight of the dressing.

2. A kit according to claim 1, wherein the cooking composition comprises less than 5% wt of hardened fats, based on the weight of the fat in the composition.

3. A kit according to either one of claims 1 or 2, wherein the cooking composition comprises up to 30% wt fat.

4. A kit according to any one of the preceding claims, wherein the cooking composition comprises flavouring agents in an amount of from 10 to 90% wt.

5. A kit according to any one of the preceding claims, wherein the dressing is an emulsion.

6. A kit according to claim 5, wherein the emulsion is an oil-in-water emulsion.

7. A kit according to any one of the preceding claims, wherein the dressing comprises 10 to 40% wt fat.

8. A kit according to any one of the preceding claims, wherein both the cooking composition and the dressing comprise fat and the weight ratio of fat in the cooking composition to fat in the dressing is in the range of from 2:1 to 1:300.

9. A kit according to any one of the preceding claims, wherein the total fat content of the cooking composition and the dressing combined is in the range of from 5 to 50 % wt.

10. A kit according to any one of the preceding claims, wherein the at least one cooked ingredient (I) is chicken, egg, meat, fish, a vegetable-derived protein source, cooked fruit, cooked vegetables or cooked bread.

11. A kit according to any one of the preceding claims, wherein the at least one fruit, vegetable or cereal product comprises salad leaves, a salad vegetable, pasta, rice, couscous.

12. A kit according to any one of the preceding claims, wherein the weight ratio of the cooking composition to dressing is in the range of from 1:20 to 2:1.

13. A process for preparing a salad comprising at least one ingredient which is cooked and at least one fruit, vegetable or cereal product, the process comprising the steps of 1) cooking the at least one ingredient in a cooking composition comprising less than 40% wt of fat and flavouring agents in an amount of from 5 to 100% by weight, based on the weight of the cooking composition, to produce at least one cooked ingredient (I), and 2) contacting the at least one fruit, vegetable or cereal product with a dressing comprising from 60% wt or less fat and 3) mixing the at least one cooked ingredient (I) with the at least one fruit, vegetable or cereal product before, during or after the fruit, vegetable or cereal product is mixed with the dressing and wherein the cooking composition and the dressing are provided as a kit for preparing a salad.

14. A salad comprising at least one ingredient which is cooked and at least one fruit, vegetable or cereal product and which salad is prepared using the kit according to any one of claims 1 to 12 and/or by the process of claim 13.
